(19) United States
(12) Patent Application Publication
(10) Pub. No.: US 2008/0155531 A1
(43) Pub. Date: Jun. 26, 2008

(54) DATA PROCESSING APPARATUS AND CONTROL METHOD THEREOF

(75) Inventor: NAOTO YAMADA, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/944,908

(22) Filed: Nov. 26, 2007

(30) Foreign Application Priority Data
Dec. 21, 2006 (JP) 2006-344398

(51) Int. Cl. G06F 9/445

(52) U.S. Cl. 717/174

(57) ABSTRACT

To install in a simple operation a resource to control a device set up at a desired position, the present invention specifies position information indicating the installed position of the device, obtains device information indicating the device installed to the installed position corresponding to the specified position information, obtains storing information for specifying a stored location of the resource for controlling the device in accordance with the obtained device information, and causes a data processing apparatus to perform an installation of the resource based on the obtained storing information.

### BACKGROUND OF THE INVENTION

1. Field of the Invention

The present invention relates to a data processing apparatus which installs a resource for using a device to cause the device to execute a process, and a control method of the data processing apparatus.

2. Description of the Related Art

In case of using peripheral devices such as a printer, a scanner and the like through a PC (personal computer), a user of the PC has to install driver software corresponding to the peripheral devices on the own PC.

More specifically, in case of newly using a desired peripheral device, the user obtains driver software corresponding the relevant peripheral device based on a service that the user wishes to use from a network or a medium such as an attached CD-ROM or the like, installs the obtained driver software on the own PC, and executes various settings for the relevant peripheral device. Then, the user can enjoy various services according to the desired peripheral device.

Besides, in an office in which a large-scale network has been provided, plural peripheral devices are generally shared by plural users through a LAN (local area network).

Incidentally, in recent years, wireless network environments have been enhanced and so-called free-address offices in which employee's sitting places are not fixed have been introduced. For these reasons, occasions to use a notebook PC have increased because of benefit and convenience of portability.

Consequently, even if a user moves from his/her own setting place to a meeting room, or even if the user changes his/her setting place day by day, the user can carry his/her own PC to the place to which he/she moved and use it there.

In such a case, to use the peripheral device set in the vicinity of the place to which the user moved, as described above, the user has to install the driver software of the relevant peripheral device and further execute the setting to actually use it.

However, contrary to the benefit and convenience of portability in use of the above notebook PC, the user has to confirm kinds of nearby peripheral devices based on the service that he/she wishes to use every time he/she uses the peripheral device at a different place. Then, the user has to search the network, select from the searched network the driver software that he/she wishes to use, download the selected driver software, and install the downloaded driver software.

Besides, if the user installs the driver software of the desired peripheral device every time he/she moves the setting place, the number of installed driver software becomes huge resultingly. Consequently, if the user actually uses the desired peripheral device, it is difficult for him/her to easily select the driver software corresponding to the used peripheral device.

Then, to prevent such a problem, the user has to uninstall the driver software of the peripheral device that he/she finished using. Accordingly, a load for the user to install and uninstall the driver software of the peripheral device increases as the user moves his/her sitting place.

To cope with the above problem, the following technique has conventionally been proposed. That is, when a client PC is activated, a printer in the same network as that the client PC is connected to is searched. Then, in a case where a new network printer is detected, the printer driver is installed to use the detected network printer (for example, Japanese Patent Application Laid-Open Nos. 2002-366502 and 2003-131827).

However, in such conventional technique, if a new printer is found and detected in the same network, the printer driver of the detected printer is installed. Accordingly, it becomes difficult to select the desired printer as the number of detected printers becomes large. That is, when the user intends to use the peripheral device, he/she has to again detect which printer driver is to be used for the peripheral device set at which place, whereby such an operation is extremely cumbersome for the user.

### SUMMARY OF THE INVENTION

The present invention is directed to a feature of providing a mechanism enabling to use a device set up at a desired position in a simple operation.

The present invention is further directed to another feature of providing a mechanism enabling to easily release resources of an unnecessary device.

Further features of the present invention will become apparent from the following description of exemplary embodiments with reference to the attached drawings.

### BRIEF DESCRIPTION OF THE DRAWINGS

FIG. 1 is a block diagram indicating the overall structure of an image processing system to which a data processing apparatus exemplifying the first embodiment of the present invention can be applied.

FIG. 2 is a view indicating an example of a database registered in a network device information manager provided in a server indicated in FIG. 1.

FIGS. 3A and 3B are views indicating examples of user interfaces to be displayed on a display device provided in a host computer indicated in FIG. 1.

FIG. 4 is a flowchart indicating an example of a first data processing procedure executed in the data processing device exemplifying the present embodiment.

FIGS. 5A, 5B and 5C are views indicating examples of user interface screens displayed in the data processing device exemplifying the present embodiment.

FIGS. 6A and 6B are views indicating examples of device driver uninstalling operation screens displayed in a data processing device exemplifying the third embodiment.

FIG. 7 is a flowchart indicating an example of a second data processing procedure executed in the data processing device exemplifying the present embodiment.

FIG. 8 is a view for describing a memory map of a storage medium for storing various data processing programs which can be read by the data processing device according to the present invention.

### DESCRIPTION OF THE EMBODIMENTS

Hereinafter, the exemplary embodiments of the present invention will be described with reference to the attached drawings.

(Description of System Structure)

### First Embodiment

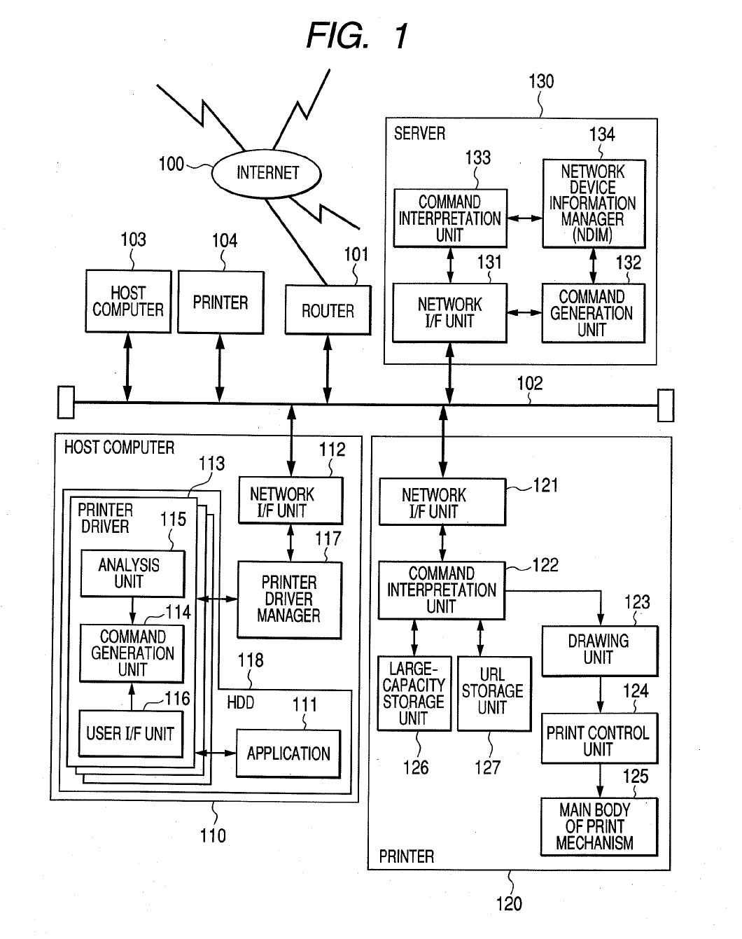

FIG. 1 is a block diagram indicating the overall structure of an image processing system to which a data processing apparatus exemplifying the first embodiment of the present invention can be applied. In the present embodiment, although an example of a printer will be given as a device, it may be a scanner acts as an input device or a complex device acts as an input/output device.

In the present embodiment, a printer driver for the printer, communication setting information (port information) used when installing the printer driver and an installer are assumed to be included as the resources. However, all of them should not be included in the resources but a part of them may be included. In addition, information other than the above instance may be included in the resources.

After a host computer 110 informed location information to a server 130, specified device information is acquired from the location information acquired by the server 130 to access a device to be selected from the device information. As an example of the location information, an example of an area (“212 meeting room”) indicating a floor where the device is installed will be given. However, it is not limited to such the information but may be code information of an area previously registered.

In the following, a case that the host computer 110 acquires resource acquisition destination information from the device and acquires the resource from the concerned URL (Uniform Resource Locator) through the Internet to perform installation will be described in detail.

In FIG. 1, the host computer 110 is connected with a LAN (Local Area Network) 102 by a network I/F unit 112 provided in this host computer. The LAN 102 is connected with the Internet 100 through a router 101. As the host computer 110, a general personal computer can be adopted.

Therefore, the host computer 110 accesses the Internet 100 and can download various data according to need.

In addition, the host computer 110 includes an application program (application) 111 and a printer driver 113 in an HDD (hard disk) 118 being a large-capacity storage area.

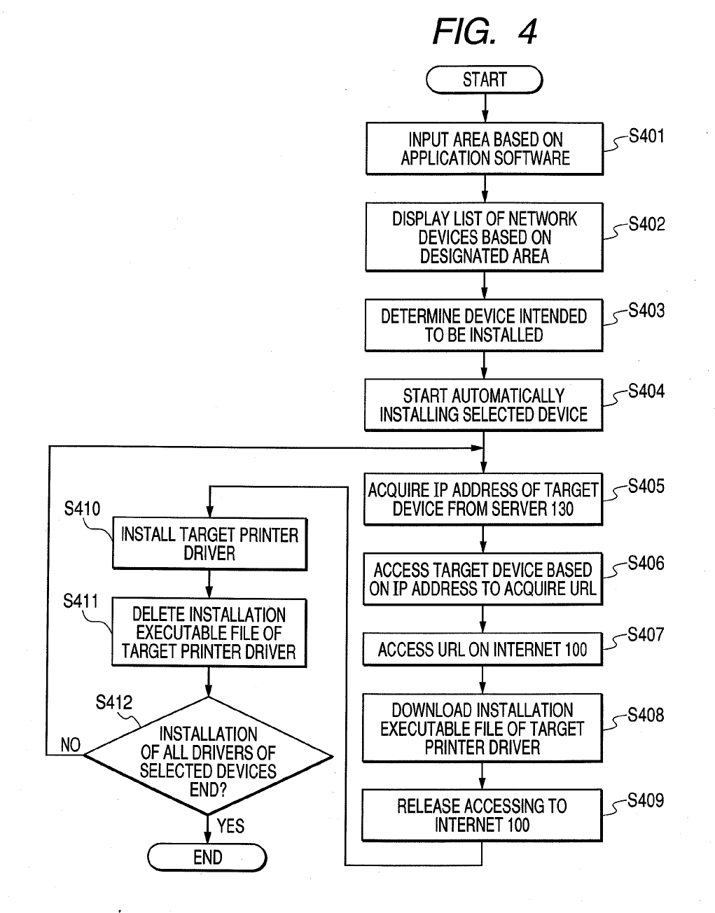

The application program 111 corresponds to word-processing software as in a word processor, drawing software, image-editing software or the like. Data of the drawn up document is converted into printing data, which can be interpreted by a printer, by the printer driver 113. Thereafter, the converted data is transmitted to a printer 104 connected with the LAN 102 through the network I/F unit 112. In addition, the application 111 also includes application software which executes processes indicated in a flowchart in FIG. 4 to be described later.

The printer driver 113 is held in the HDD 118 every kind of the printer to be used for the print as an individualized program, and printing data to be generated have different forms according to a kind of the printer.

For example, with respect to a printer driver of an inkjet printer for performing the print every scanning line of a printer head, all the print data is converted into image data and then the converted data is transmitted. On the other hand, with respect to a printer driver of a laser beam printer capable of performing the print with a page unit, data of characters is transmitted as character data and data of graphic forms is transmitted as graphic data (drawing command).

Note that the printer driver 113 is constituted by a command generation unit 114, an analysis unit 115 and a user I/F unit 116.

The analysis unit 115 analyzes character data, graphic data and image data transferred from the application 111. In the command generation unit 114, the data is converted into commands which can be interpreted by a printer 120 or the printer 104 to be transmitted to the printer 120 or the printer 104 through the network I/F unit 112.

Note that the user I/F unit 116 corresponds to a program to designate resolution, color/monochrome, single-sided print/double-sided print when a user performs the print. Designation by the user is reflected in commands generated by the command generation unit 114.

A printer driver manager 117 manages the printer driver 113 currently installed in the host computer 110 and manages a matter that the printer driver is currently assigning to which the port, that is, which the printer. Then, an automatic installing process of the printer driver is performed according to need.

In the present embodiment, the printer driver manager 117 executes the following processes.

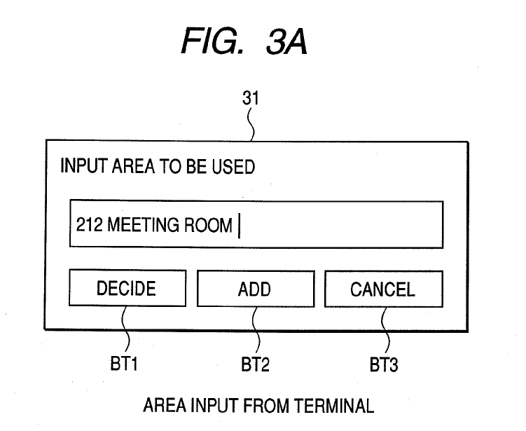

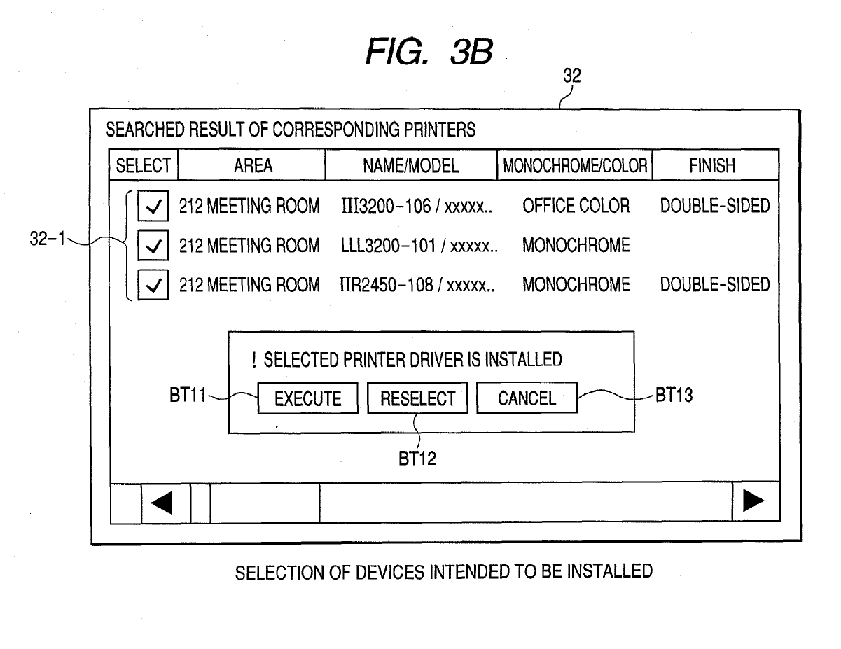

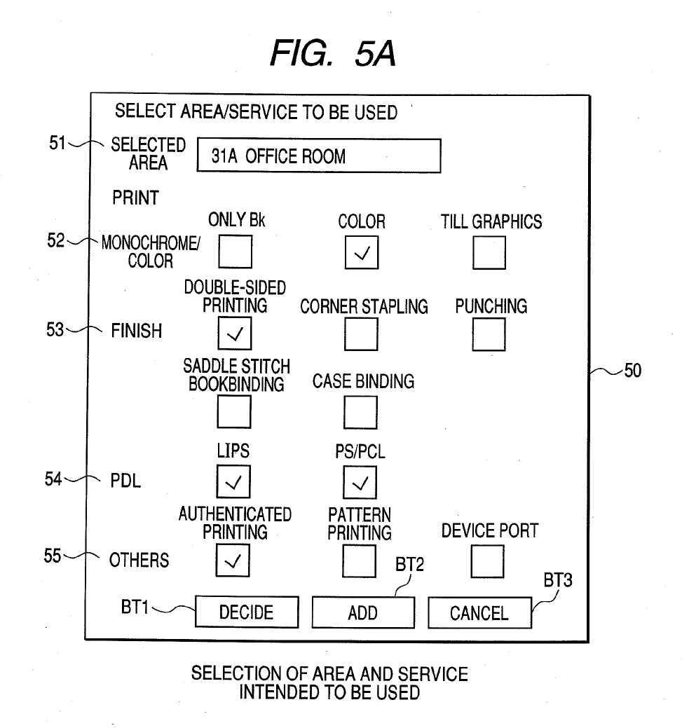

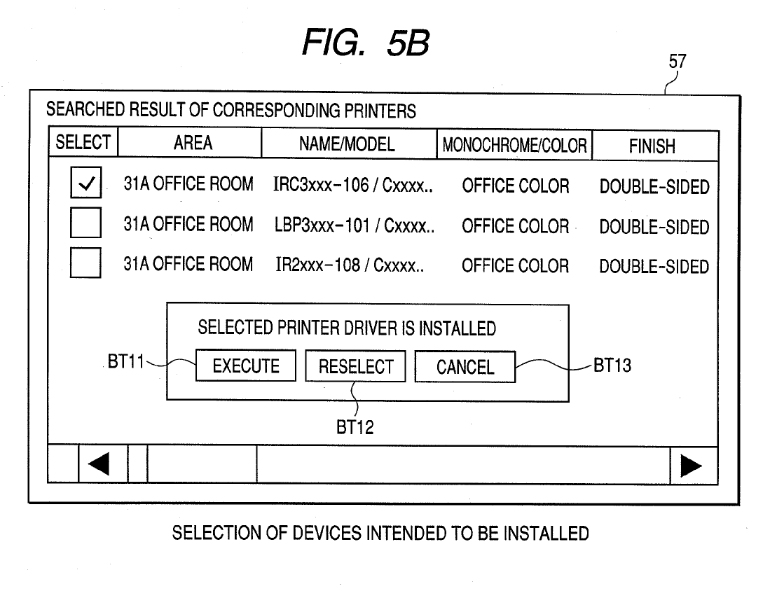

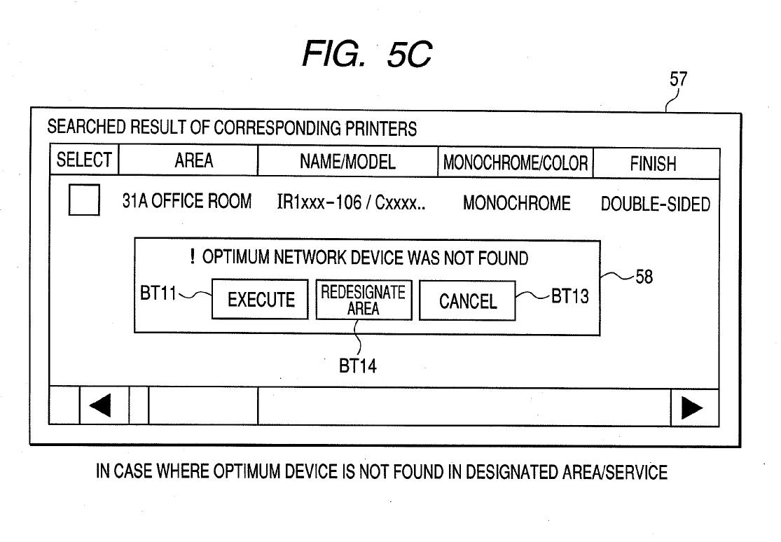

The printer driver manager 117 has a first acquisition function for acquiring device information specified by the location information from the server 130 after transmitting the location information to be input to the server 130. Consequently, a device managed every area by the server 130 can be specified. Note that the location information to be input will be indicated in FIGS. 3A and 5A, and examples of the device information will be indicated in FIGS. 3B and 5B.

The printer driver manager 117 has a second acquisition function for acquiring the resource acquisition destination information from any device (for example, printer 120) to be selected among the device information. Here, the resource acquisition destination information is assumed to be a URL specified on the Internet 100 as described later.

Furthermore, the printer driver manager 117 has an installing function for downloading the resource to be acquired from the network on the basis of the resource acquisition destination information and starting to install the resource. Since the installer is included in the resource to be acquired from the Internet 100, the driver can be installed in accordance with the printer driver and port information included in the resource by an operation that a user instructs an execution of the installer.

Plural host computers can be connected with the LAN 102, and another host computer is denoted by reference numeral 103.

The printer 120, which is connected with the LAN 102 by a network I/F unit 121 provided in this printer, executes a printing process in accordance with printing data transmitted from the host computer 110 or the host computer 103.

In the printer 120, data received at the network I/F unit 121 is interpreted by a command interpretation unit 122 and the printing data is converted into internal drawing data to be transferred to a drawing unit 123.

In a case that a printer main body is a page printer, the drawing unit 123 stores drawing data for one page, and when terminating indication for one page is issued, the drawing data stored for one page is rasterized into bitmap data to be transmitted to a print control unit 124. The print control unit 124 transfers the bitmap data received from the drawing unit 123 to a main body of print mechanism 125 while synchronizing with the main body of print mechanism 125 to perform the printing.

A large-capacity storage unit 126, which is structured by a hard disk or a large-capacity RAM, can store form data, font data and the like.

A URL storage unit 127, which is structured by a ROM or a RAM, stores a location of a server used for downloading a printer driver of the updated version.

The server 130 is connected with the LAN 102 by a network I/F unit 131 provided in this server. The server 130 reads data which is in an NDIM (network device information manager) 134 depending on commands transmitted from the host computer 110 or the printer 120 by a command interpretation unit 133. The server 130 performs a control of a writing process, converts the above-mentioned data into command data by using a command generation unit 132 and transmits data to the LAN through the network I/F unit 131. Another printer is denoted by reference numeral 104. It is general that plural printers are connected with the LAN 102 in consideration of a printing purpose and frequency of use.

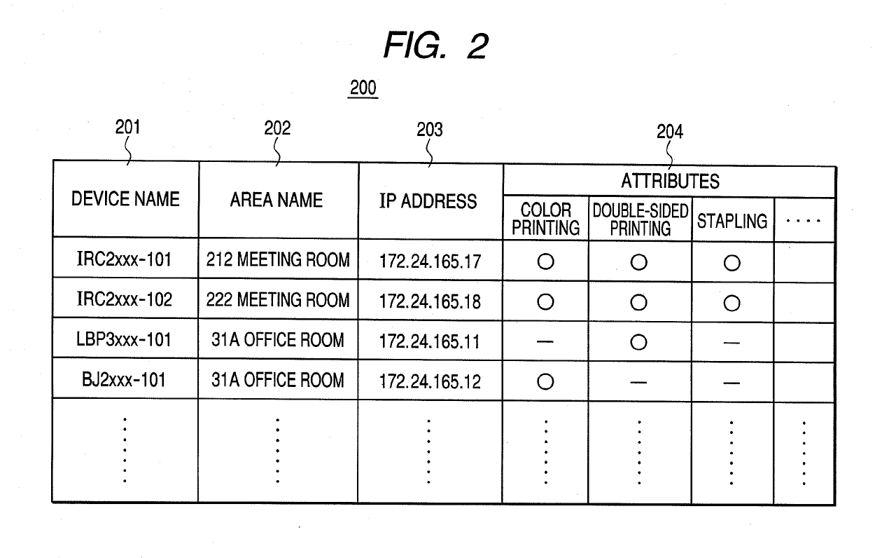

FIG. 2 is a view indicating an example of a database 200 registered in the NDIM 134 provided in the server 130 indicated in FIG. 1. Note that data in each line indicates data regarding the each one device.

In FIG. 2, a column 201 in each line indicates a name of the each device. A column 202 indicates area information of indicating area where the each device is installed. A column 203 indicates a network address (IP address) of the each device. A column 204 indicates attributes information of indicating whether or not various functions such as a color printing function, a double-sided printing function and a stapling function are supported. Added marks “o” (white circle) mean that the corresponded functions are supported.

Information as in FIG. 2 of the each device connected with the LAN 102 can be referred by accessing the NDIM 134 of the server through the application software on the host computer 110 by a user.

Next, the search of a printer by the area designation and an automatic installing process of a desired printer driver being the feature of the present embodiment will be described. It is assumed that application software for executing the automatic installing process of this driver is installed in the host computer 110.

FIGS. 3A and 3B are views indicating examples of user interfaces to be displayed on a display device provided in the host computer 110 indicated in FIG. 1.

Note that FIG. 3A corresponds to an area input screen 31 to be used, and FIG. 3B corresponds to a device search window 32.

FIG. 3A indicates an example of a screen when the present application software was started up. A user connects the own notebook-size PC to the network. And, in this screen, an area such as the “212 meeting room”, where a device wanted to be used by a user is installed, is input by operating, for example, a keyboard. The area mentioned here is not an area on a network such as an IP address but an area which can specify a floor or the like where the device is installed.

In this manner, when an input of the “212 meeting room” is performed, the user depresses an “execution” button by clicking it with a pointing device (not illustrated). Consequently, information of a device installed in the vicinity of the corresponded area is inquired to the server 130 from the host computer 110 through the LAN 102.

The server 130 compares the area information input by the user with area attribute of the device previously registered in the above-mentioned NDIM 134 and calls up a search result of the device in an area which corresponds to the area input by the user. Then, the search result is transmitted to the host computer 110.

In this manner, the host computer 110 receives device information corresponding to areas and presents the search result to the user by displaying the device search window 32 indicated in FIG. 3B on a display device. This example corresponds to a state, where, for example, three printers are searched as devices installed at the “212 meeting room”.

In this example, with regard to the device information, the user is enabled to easily grasp information about the device by displaying also the functional attributes (for example, monochrome/color, finishing function) held by the device other than a model name of the device.

Consequently, the user starts a process for an automatic installation of the driver software for the targeted devices by clicking an “execution” button BT11 with a pointing device after the decision confirmed by making checks in a selection portion 32-1 of the device to which the each driver software is desired to be installed.

Note that if a cancellation button BT13 is clicked, an operation is ended without installing the driver of the device. And, a reselection button is denoted by a reference symbol BT12.

When an installation of the driver of the selected device is instructed on the device search window indicated in FIG. 3B, the printer driver manager 117 executes an automatic installing process of the printer driver. A processing procedure of the automatic installing process of the printer driver will be described in detail with reference to a flowchart in FIG. 4.

FIG. 4 is a flowchart indicating a first data processing procedure of the present embodiment. This example is an example of the automatic installing process of the printer driver. Respective steps are denoted by reference symbols S401 to S412. And, each of the steps is attained by a process that a CPU of the host computer 110 downloads a control program to a RAM and executes that program. This example is an example of such a process where the printer in the “212 meeting room” is searched and the driver thereof is installed.

First, application software used for executing a first data processing procedure is activated in the step S401, and when an area, where the device desired to be utilized by the user is installed, is designated on a screen indicated in FIG. 3A, information of specifying the area is input (S401). Consequently, network device information corresponding to the input areas is acquired from the server 130, and a list is displayed on the device search window 32 in the step S402.

Next, in the step S403, the device to which the driver is desired to be installed is selected by the user on the device search window 32 indicated in FIG. 3B. When a check is made in the selection portion 32-1 corresponding to the printer which can be utilized in the “212 meeting room”, the corresponded printer is fixed as the device to be used. Next, in the step S404, when the “execution” button BT11 is depressed, a process for installing the driver of the selected device is started.

In the step S405, an IP address, which is assigned to the printer made a check in the selection portion 32-1, is called out from the server 130 and acquired.

Furthermore, in the step S406, a URL (it is stored in the URL storage unit 127 provided in the printer 120) indicating an acquiring destination of the printer driver is acquired by accessing the printer on the basis of the IP address.

Note that the communication between the host computer 110 and the printer 120 is performed by the respective network I/F units 112 and 121 by using a predetermined protocol in the LAN 102.

An acquisition request of the URL of the printer driver by the printer driver manager 117 in the host computer 110 is transmitted as a printer control command to be interpreted by the command interpretation unit 122 in the printer 120.

In this manner, the printer 120 reads the URL of the printer driver stored in the URL storage unit 127 for an acquisition request of the URL of the printer driver requested from the host computer 110. Then, the printer 120 transmits the read URL to the host computer 110.

Note that a particular URL is stored in the URL storage unit 127 every type of the devices. For example, it is assumed that the particular URL is held by a character row such as “http://www.XXX.co.jp/Printer Driver/III3150.html”.

In this manner, when the URL of the printer driver corresponding to the printer which can be utilized in the “212 meeting room” is acquired, the printer driver manager 117 in the host computer 110 accesses the URL on the Internet 100 in the step S407. Then, in the step S408, an installation executable file of the printer driver corresponding to the printer which can be utilized in the “212 meeting room” is downloaded.

In this manner, when a download of the installation executable file corresponding to the printer which can be utilized in the “212 meeting room” is completed, it is released to access the Internet in the step S409.

Subsequently, in the step S410, the printer driver manager 117 installs the printer driver acquired from the URL (http://www.XXX.co.jp/Printer Driver/III3150.html) on the Internet. It is allowed that an installer is automatically activated according to the termination of the download to start the installation. At this moment, a screen for inquiring of the user whether or not the installation may be started is displayed. For this inquiry, when the user instructs to start the installation, it is allowed to start the installation. At this time, it is instructed to start the installation from the present application software to the installer of the printer driver.

The installation executable file downloaded from the URL on the Internet 100 is such a program which can be executed on the host computer 110, and a renewed printer driver is installed to be able to use by executing this program. When installing the driver, this program performs various settings for utilizing the driver cooperating with an OS (Operating System).

In this manner, when the installation of the printer driver is completed, the installation executable file downloaded in the step S408 is deleted in the step S411 at the end, and the automatic installation of the printer driver is ended.

Then, in the step S412, the user designates an area, and it is determined whether or not the installation of all the drivers of the devices selected as in FIG. 3B is ended. An automatic installing operation of the driver software of the arbitrary device within the area designated by the user is ended by repeating a flow from the step S405 to the step S412 until it is completed.

As above mentioned, in an image processing system of the present embodiment, for example, in a case that the user moves from a seat and wants to use a desired peripheral device or the user wants to output prints in an arbitrary place, the following effect is exhibited.

The user searches the driver of the device connected with a network within a designated area by designating a desired area from the host computer, and the automatic installation can be performed. Therefore, when the user connects a PC with a network at the destination, the user easily accesses a device within a selected area and can have a service of using a selectable device at the destination.

In the present embodiment, although an inputting operation is performed by a form of describing a place of an actual installed area as it is, a form of describing an area as an encoded area, for example, such as “A3-201” is allowed.

In addition, such a form capable of designating plural areas at once, that is, for example, capable of designating two places of the “212 meeting room and 222 meeting room” at once is allowed.

In the present embodiment, a case that an area is designated by describing the area in a predetermined column after starting up the application software has been described.

Compared with this, it is allowed that the area is specified as follows by utilizing a system of giving authentication by using an ID (identification) card when the user enters the area. That is, in a case that the user is permitted to enter the area by an ID card reader of this system on the basis of user information stored in the ID card, area information of a place where the user stays is made to be stored in the ID card by the ID card reader. The area information of the place where the user stays may be read from the card by providing a system that the host computer 110 is made to read the information stored in the ID card. In addition, it is allowed that the place where the user stays is specified by various manners and the software of the corresponded device and the driver for utilizing that device can be installed.

In the above description, an acquiring destination of the driver is set to acquire from the device itself. However, a URL of the acquiring destination of the driver is also registered in the NDIM 134 thereby the acquiring destination can be acquired from the server 130.

In addition, the driver is made to be stored in the large-capacity storage unit 126 in the printer 120 from which it may be acquired, or the driver is made to be stored in the server 130 from which it may be acquired.

### Second Embodiment

In the above-mentioned embodiment, a case that a list of the searched devices is displayed on the device search window 32 indicated in FIG. 3B by designating information of the area by the user has been described. However, in a case that various devices are connected with a network in a currently connected area, there is a case that printers other than a printer, of which attribute is desired by a user, are also connected with the network. In this case, since various device information are displayed on a list, the user is required to decide a desired device by referring attributes one by one among the various information.

Therefore, it may be structured that the load in searching the device for the user can be reduced by controlling to display the device information on the device search window by narrowing down the printers of which attributes are desired by the user. Hereinafter, the embodiment for the above description (second embodiment) will be described.

Since the structure of an image processing system according to the present embodiment is same as that of the first embodiment indicated in FIG. 1 and details have been mentioned, the description thereof will be omitted.

Also, in the present embodiment, in the application within the host computer 110, the client software for searching the network device is installed similar to a case in the first embodiment. And, it is assumed that the search of a network device according to area information and a service function described below is performed. Note that the client software is called the network device searching software hereinafter.

Therefore, in the present embodiment, the above-mentioned network device searching software is used and the user inputs the area information similar to a case in the first embodiment. In addition, a list of services wanted to use is displayed as described later and the most suitable device is selected by selecting the service.

FIGS. 5A, 5B and 5C are views indicating examples of user interface screens displayed in the data processing device exemplifying the present embodiment. The present example is an example of a screen when the network device searching software was started up.

In the present embodiment, it is assumed to be structured that a searching process is executed by designating an area to be used and selecting functions of services wanted to use. In the present embodiment, a selectable device for the user is made to be easily selected by narrowing down selectable devices to become candidates within the same area by previously inputting function (attribute), a control language and service wanted to be used by the user in addition to the selective area indicated in the first embodiment. Here, as the control language, there are the LIPS™ (Laser beam printer Image Processing System), the PS (PostScript™) and the like.

As indicated in FIG. 5A, if a network printer is enumerated as an example, it is assumed that information related to the service is created by designating one or more services among a “monochrome/color” 52 which indicates presence or absence of a color printing function, a “finish” 53 which indicates presence or absence of a stapling function and a double-sided printing function, a “PDL” 54 which indicates kind of the control language and an “others” 55 which indicates attributes other than the above-mentioned services besides the designation of a “selected area” 51.

When an inputting operation is performed, an inquiring process is executed from the host computer 110 to the server 130 through the LAN 102 by clicking an “execution” button BT1 with a pointing device (not illustrated) similar to a case in the first embodiment.

In the present embodiment, the server 130 treats also a part corresponding to the attributes 204 in the information indicated in FIG. 2 as a search target according to the designation indicated in FIG. 5A other than area information of the devices for the above-mentioned NDIM 134, and the search narrowed down is performed.

In this manner, the server 130 searches a device, which is installed within an area input at the selected area 51 and corresponds to the attributes designated at the above-mentioned sections 52 to 54, and then the server 130 transmits the searched result to the host computer 110.

The host computer 110 receives the searched result and presents the searched result to the user by displaying a device search window 57 indicated in FIG. 5B on a display device.

Consequently, the user decides a device by making a check for the device to which a diver is desired to be installed as in the device search window 57 in FIG. 5B. Thereafter, an automatic installation of the driver software for the targeted device is started by clicking the “execution” button BT11 with a pointing device.

Note that when a cancellation button is clicked, an installation for the device is not performed to be ended.

A processing procedure of an automatic installing process of the printer driver selected this time is similar to that in the first embodiment and indicated by a flowchart as in FIG. 4.

Consequently, in the present embodiment, the driver software for the most suitable device can be automatically installed by adding service information desired to use in addition to the area information by the user.

Although a device within a designated area is searched by inputting the service desired to use this time, there is a case that a device having the designated service cannot be found within the designated area.

Therefore, in a case that the device which can perform the designated service (attributes) can not be found within the designated area, the device within the designated area is displayed even if the service does not completely coincide with the designated service, and it is allowed to display a screen capable of understanding services which can not be used among the designated services. As in FIG. 5C, the displaying structure, where the area can be redesignated after displaying a message 58 informing a fact that the most suitable device could not be found, may be allowed.

In FIG. 5C, an area redesignating button 14 is depressed in case of displaying the area 51 in FIG. 5A used for designating the area from a display screen in FIG. 5C. Then processes can be tried again from the step S401.

When the device, of which the service completely coincides with the designated service, could not be found, it is allowed that the device, which is installed outside the designated area but installed in the vicinity of the designated area and can perform the designated service, is automatically searched.

### Third Embodiment

Next, the third embodiment of the present invention will be described. Since the structure of an image processing system according to the present embodiment is same as that of the first embodiment and details have been mentioned in the above instance, the description thereof will be omitted.

The third embodiment relates to a process of uninstalling a driver of the device installed as mentioned in the first and second embodiments.

In the present embodiment, the printer driver manager 117 in the host computer 110 has a determination function of determining whether or not the first location information which was input at a time of the previous installation of the driver coincides with second location information to be input newly. That is, in a case that the driver was installed according to the processes in the first and second embodiments, the area information which was input in the step S401 is stored in the printer driver manager 117. In a case that area information is newly input in the step S401 and a new driver is installed, it is determined whether or not it coincides with the stored area information. Herewith, it is determined that the user moves while having the host computer 110 on the network, and an installation of a necessary device driver and an uninstallation of an unnecessary device driver can be surely performed every change of the moving destination as described below.

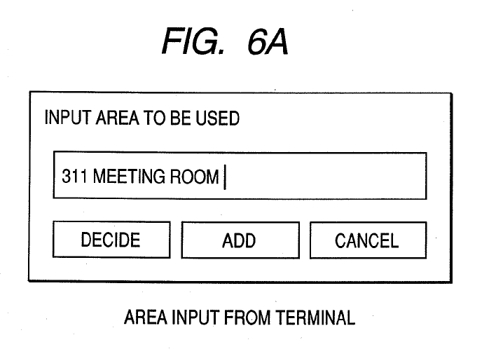

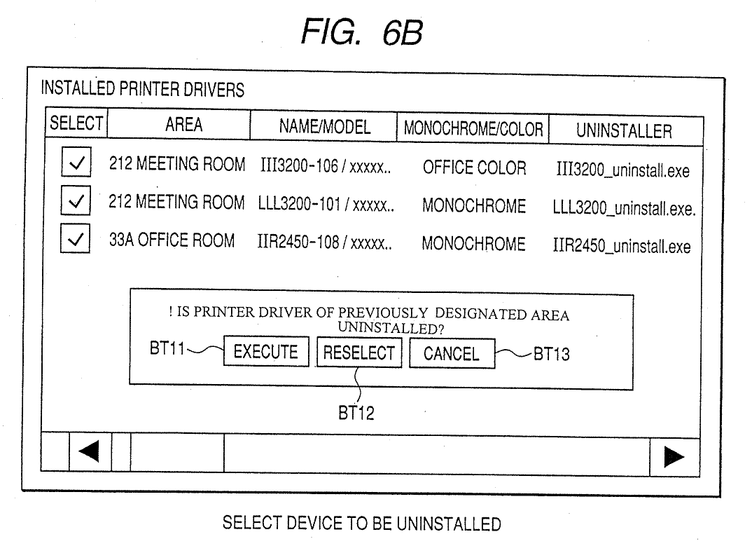

When it was determined that the first location information does not coincide with the second location information by the determination function of the printer driver manager 117, the resource information of the device corresponding to the first location information to be uninstalled is displayed (refer to a screen in FIG. 6B).

The device to be uninstalled is selected from a list on the screen in FIG. 6B displayed by the display function of the printer driver manager 117. In this manner, the printer driver manager 117 uninstalls the resource of the device selected by an operation of the user from the HDD 118. Consequently, a free-space in the HDD 118 is saved and a memory can be effectively utilized. Furthermore, such a situation, where the selection of the driver becomes difficult when the user intends to actually use the driver because a large amount of the divers are remained to be installed, can be prevented.

FIGS. 6A and 6B are views indicating examples of device driver uninstalling operation screens displayed in a data processing device exemplifying the third embodiment.

In the present embodiment, the user connects the own notebook-size PC with the network via a network cable similar to cases in the first and second embodiments.

The above-mentioned application software is started up, and an area desired to be used by the user such as the “311 meeting room” as in FIG. 6A is input by the same method by using an application screen. Area information is to be designated without distinction of installation and uninstallation, and a screen in FIG. 6A is displayed by the same procedure as that for the screen in FIG. 3A.

Then, when the area information is input by the user and decided, the host computer 110 confirms the area information which was designated at a time of the previous installation and managed by the application software and driver information of the device installed according to the area designation. In a case that the area information designated this time differs from the area information designated at the last time, an instruction which recommends the uninstallation of the previous driver software is displayed as in FIG. 6B. Herewith, an automatic uninstallation of the driver software, which was installed at a time of the previous area designation, is to be performed by clicking the “execution” button BT11 with a pointing device by the user. Hereinafter, a procedure of the automatic uninstallation will be described with reference to a flowchart.

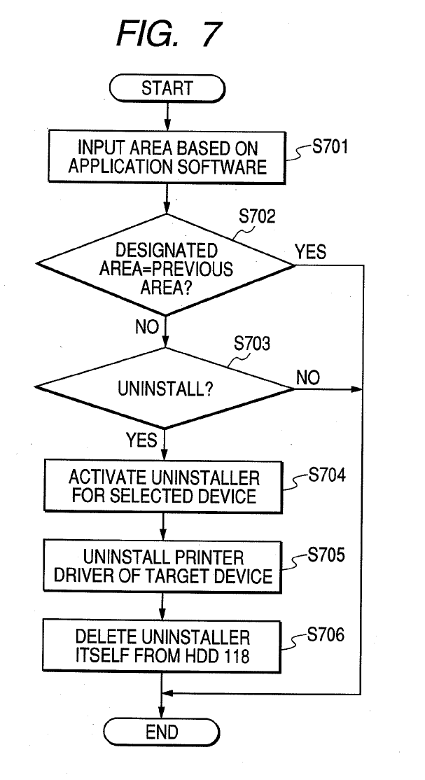

FIG. 7 is a flowchart indicating an example of a second data processing procedure exemplifying the embodiment of the present invention. The present example is an example of an automatic uninstalling process of the printer driver. Note that respective steps are denoted by reference symbols S701 to S706. The respective steps are attained by loading a control program to a RAM by a CPU in the host computer 110 and executing the control program.

First, in the step S701, the user activates the application software similar to a case in the above-mentioned embodiment and an area designated by the user this time is input. Next, in the step S702, it is determined whether or not the area designated this time coincides with the previous designated area. At this moment, when it is determined that the area designated this time is different from the previous designated area, such a screen which indicates whether or not a collective uninstallation of the drivers installed at a time of the previous area designation is executed is displayed in the step S703. At this moment, a confirmation screen of the installed printer drivers indicated in FIG. 6B is displayed, and a fact that the area designated this time is different from the previous designated area is informed to the user. While, in the step S702, when it was determined that the area designated this time coincides with the previous designated area, the present process is ended.

Here, it is determined whether or not a collective uninstallation is required by an action that the user depresses the button BT11 indicated in FIG. 6B, that is, it is determined whether or not the uninstallation is performed. When it is determined that the uninstallation is not performed, the present process is ended. The process may be ended after displaying a message, which indicates a fact that a driver of the device installed in an area designated this time has been already installed.

Next, in the step S704, the printer driver installed at the last time ends to provide the essential function of the printer driver and activates an uninstaller of the printer driver.

The uninstaller of the printer driver (illustrated as “***_uninstall.exe” in FIG. 6B) is stored in the hard disk 118 as a part of data in the printer driver.

Then, in the step S705, the printer driver manager 117 reads an uninstaller stored in the hard disk 118 for a RAM (not illustrated) provided in the printer driver manager 117 to activate. The uninstaller uninstalls the printer driver by operating on the RAM of the printer driver manager 117. Next, in the step S706, data of the printer driver is erased from the hard disk 118 also including data of the uninstaller itself, and the present process is ended.

Thereafter, an area in the hard disk 118, to which the data of the printer driver was stored, can be used for storing another data.

In this manner, the host computer 110 continues an installing process according to the area designation as in the first and second embodiments after ending the uninstallation.

In this uninstalling process, when a file to be deleted at the driver targeted to be uninstalled is used at another driver, the file is not deleted, and only a file which does not influence an operation of another driver is assumed to be deleted even if it is deleted.

As mentioned above, in a case that the previous designated area is different from the area designated this time, a screen indicating that the uninstallation is automatically performed is displayed to realize the structure capable of performing the uninstallation. Consequently, it is prevented to increase the amount of data stored in the hard disk area of a personal computer of the user by an effect of the printer driver in an area not to be used. In addition, the processing efficiency of the personal computer can be improved by the uninstallation. Furthermore, such a situation, where a large amount of drivers are remained to be installed and when the user wants to use the driver actually, the selection of the driver becomes difficult, can be prevented.

Since the uninstallation is to be performed when it could be decided that the user moved from the area after the user installed the driver, there is not such an inconvenience to be performed the uninstallation when the user still stays in the area.

In the first to third embodiments, the installation and uninstallation all based on the area designation of the printer drivers have been described.

However, the present invention can be applied to any network devices if they are connected with a network and registered about areas. For example, the present invention can be also applied to an automatic installation of drivers for a scanner and a digital camera which can be connected with the network.

### Fourth Embodiment

In the above-mentioned embodiments, a case that a name of the meeting room is input as the location information (area information) for acquiring the resources has been described. However, there is a case that an area specified by the location information is managed as an area having a certain overlapped part. Therefore, it is allowed to increase the convenience at a boundary between areas relevant to the move of a user by enabling to manage the location information to be managed by a server as the area having a certain overlapped part.

According to the above embodiment, since the resource to enable to utilize a device by specifying the location of the device desired to be utilized by an operator can be installed, the device installed at a desired location can be utilized with a simple operation. And, the resource becomes unnecessary can be easily uninstalled.

### Fifth Embodiment

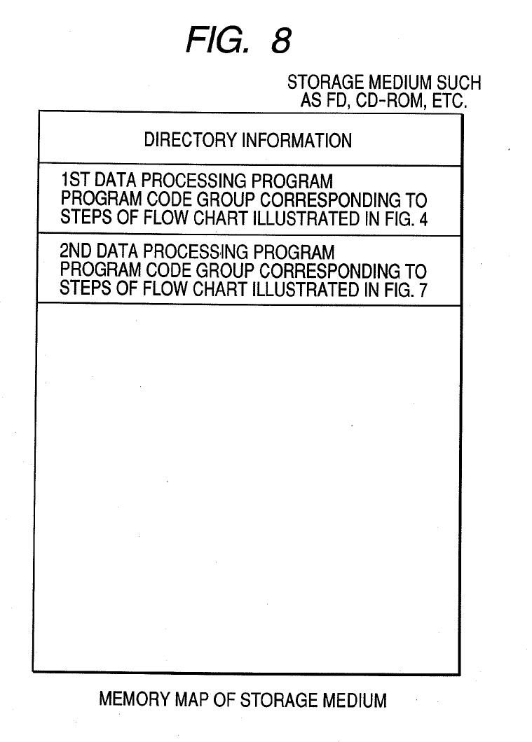

Hereinafter, the architecture of data processing programs readable by the data processing apparatus according to the present invention will be described with reference to a memory map illustrated in FIG. 8.

FIG. 8 is the diagram for describing the memory map of a storage medium which stores the various data processing programs readable by the data processing device according to the present invention.

Although it is not illustrated specifically, also information (e.g., version information, creator information, etc.) for administrating the program groups stored in the storage medium may occasionally be stored in the storage medium, and information (e.g., icon information for discriminatively displaying a program, etc.) depending on an OS or the like on the program reading side may occasionally be stored in the storage medium.

Moreover, the data depending on the various programs are administrated on the directory of the storage medium. Besides, a program to install various programs into a computer, a program to uncompress installed programs and data when the installed programs and data have been compressed, and the like are occasionally stored.

Furthermore, the functions illustrated in FIGS. 4 and 7 may be executed by a host computer based on externally installed programs. In that case, the present invention is applicable even in a case where an information group including programs is supplied from a storage medium (such as a CD-ROM, a flash memory, an FD (floppy disk) or the like) or an external storage medium through a network to an output device.

As described above, it is needless to say that the object of the present invention can be achieved in a case where the storage medium storing the program codes of software to realize the functions of the above embodiments is supplied to a system or an apparatus and then a computer (or CPU or MPU) in the system or the apparatus reads and executes the program codes stored in the storage medium.

In that case, the program codes themselves read from the storage medium realize the new functions of the present invention, whereby the storage medium storing the relevant program codes constitutes the present invention.

Accordingly, because the form of program is no object if it has an actual function as the program, an object code, a program executed by an interpreter, script data supplied to an OS, and the like may be included as the program.

As the storage medium for supplying the program codes, for example, a flexible disk, a hard disk, an optical disk, a magnetooptical (MO) disk, a CR-ROM, a CD-R, a CD-RW, a magnetic tape, a nonvolatile memory card, a ROM, a DVD, or the like can be used.

In that case, the program codes themselves read from the storage medium realize the functions of the above embodiments, whereby the storage medium storing these program codes constitutes the present invention.

Besides, as a method of supplying programs, there is a method of connecting with a website on the Internet by using a browser of a client computer, and downloading the computer program itself of the present invention or a compressed file including an automatic installing function together with the computer program into the recording medium such as a hard disk or the like. Moreover, there is a method of dividing the program codes constituting the program of the present invention into plural files and downloading the respective files from different websites. That is, a WWW server, an ftp (file transfer protocol) server and the like for downloading the program files for achieving the function processes of the present invention with use of the computer to plural operators are included in the scope of the present invention.

Moreover, it is possible to encrypt the program of the present invention, store the encrypted program in a storage medium such as a CD-ROM or the like, distribute the obtained storage media to users, cause the user who has satisfied a predetermined condition to download key information for decrypting the encrypted program from the website through the Internet, cause the relevant user to install the decrypted program into an appropriate computer, and thus achieve the functions of the present invention.

Moreover, it is needless to say that the present invention includes not only a case where the functions of the above embodiments are realized by executing the program codes read by the computer, but also a case where an OS (operating system) or the like functioning on the computer executes a part or the whole of the actual process according to instructions of the program codes, whereby the functions of the above embodiments are achieved by that process.

Moreover, it is needless to say that the functions of the above embodiments can be achieved in a case where the program read from the storage medium is once written in a memory provided in a function expansion board inserted in the computer or a function expansion unit connected to the computer, and then a CPU or the like provided in the function expansion board or the function expansion unit executes a part or the whole of the actual process according to the instructions of the program.

While the present invention has been described with reference to what is presently considered to be the exemplary embodiments, it is to be understood that the present invention is not limited to the disclosed embodiments. On the contrary, the present invention is intended to cover various modifications and equivalent arrangements (including the organic combination of respective embodiments) included within the scope of the appended claims.

Although the embodiments have been explained by way of various examples, it is apparent for one of ordinary skill in the art that the purpose and the scope of the present invention are not limited to the specific explanations described in the present application.

This application claims the benefit of Japanese Patent Application No. 2006-344398, filed Dec. 21, 2006, which is hereby incorporated by reference herein in its entirety.

What is claimed is:

1. A data processing apparatus comprising:
a specifying unit configured to specify position information indicating an installed position of a device;
a first obtaining unit configured to obtain device information indicating the device installed to the installed position corresponding to the position information specified by the specifying unit;
a second obtaining unit configured to obtain storing information for specifying a stored location of a resource for controlling the device in accordance with the device information obtained by the first obtaining unit; and
an installing unit configured to cause the data processing apparatus to perform installation of the resource based on the storing information obtained by the second obtaining unit.

2. The data processing apparatus according to claim 1, further comprising a determining unit configured to determine a present location of the data processing apparatus,
wherein the specifying unit specifies the position information based on the present location of the data processing apparatus determined by the determining unit.

3. The data processing apparatus according to claim 1, further comprising:
a displaying unit configured to display a list of the devices corresponding to the device information obtained by the first obtaining unit; and
a selecting unit configured to select the device from the list displayed by the displaying unit,
wherein the installing unit causes the data processing apparatus to perform the installation of the resource for controlling the device selected by the selecting unit.

4. The data processing apparatus according to claim 1, further comprising a designating unit configured to designate an attribute of the device,
wherein the first obtaining unit obtains the device information corresponding to the position information specified by the specifying unit and the attribute designated by the designating unit.

5. The data processing apparatus according to claim 1, further comprising:
a judging unit configured to judge whether or not an installed position of the device corresponding to the resource previously installed in the data processing apparatus and an installed position corresponding to the position information newly specified by the specifying unit coincide with each other; and
an uninstalling unit configured to cause the data processing apparatus to perform uninstallation of the resource previously installed in the data processing apparatus in a case where it is judged by the judging unit that the two installed positions do coincide with each other.

6. A controlling method for a data processing apparatus, comprising:
specifying position information indicating an installed position of a device;
obtaining device information indicating the device installed to the installed position corresponding to the specified position information;
obtaining storing information for specifying a stored location of a resource for controlling the device in accordance with the obtained device information; and
causing the data processing apparatus to perform installation of the resource based on the obtained storing information.

7. The controlling method according to claim 6, further comprising determining a present location of the data processing apparatus,
wherein the specified position information is based on the determined present location of the data processing apparatus.

8. The controlling method according to claim 6, further comprising:
displaying a list of devices corresponding to the obtained device information; and
selecting a device from the displayed list,
wherein the installed resource is for controlling the selected device.

9. The controlling method according to claim 6, further comprising designating an attribute of the device,
wherein the obtained device information corresponds to the specified position information and the designated attribute.

10. The controlling method according to claim 6, further comprising:
judging whether or not an installed position of the device corresponding to the resource previously installed in the data processing apparatus and an installed position corresponding to the position information newly specified coincide with each other; and
causing the data processing apparatus to perform uninstallation of the resource previously installed in the data processing apparatus in a case where it is judged that the two installed positions do not coincide with each other.

11. A computer executable program, which is stored in a computer readable storage medium, for performing a controlling method for a data processing apparatus, the method comprising:
specifying position information indicating an installed position of a device;
obtaining device information indicating the device installed to the installed position corresponding to the specified position information;
obtaining storing information for specifying a stored location of a resource for controlling the device in accordance with the obtained device information; and
causing the data processing apparatus to perform installation of the resource based on the obtained storing information.
